(19) United States
(12) Patent Application Publication
(10) Pub. No.: US 2025/0153698 A1
(43) Pub. Date: May 15, 2025

(54) ELECTRONIC BRAKE SYSTEM AND OPERATION METHOD THEREOF

(71) Applicant: HL MANDO CORPORATION, Gyeonggi-do (KR)

(72) Inventors: Hyundong KIM, Gyeonggi-do (KR); Sooyong JEON, Gyeonggi-do (KR); Yeonseong KIM, Gyeonggi-do (KR); Heejun KIM, Gyeonggi-do (KR)

(21) Appl. No.: 18/780,467

(22) Filed: Jul. 22, 2024

(30) Foreign Application Priority Data
Nov. 9, 2023 (KR) 10-2023-0154861

(51) Int. Cl. B60T 13/68; B60T 13/14; B60T 13/74

(52) U.S. Cl. CPC B60T 13/686; B60T 13/142; B60T 13/745

(57) ABSTRACT

An electronic brake system includes: a plurality of actuators provided in a plurality of wheels, respectively and providing power for braking; and a hydraulic braking device providing braking force by a hydraulic pressure to at least one wheel cylinder of the plurality of wheels when the actuator is inoperable, the hydraulic braking device includes a reservoir storing a pressing medium, a master cylinder including a master piston connected to a brake pedal, a master chamber of which a volume is varied by displacement of the master piston, and a pedal simulator disposed inside the master chamber and providing a pedal feeling through an elastic restoration force generated during compression, a connection path connecting the master chamber and the wheel cylinder, and a cut valve provided in the connection path, and controlling a flow of the pressing medium between the master cylinder and the wheel cylinder.

### CROSS-REFERENCE TO RELATED APPLICATIONS

This application claims the benefit of and priority of Korean Patent Application No. 10-2023-0154861 filed on Nov. 9, 2023 in the Korean Intellectual Property Office, the disclosure of which is incorporated herein by reference in its entirety.

### BACKGROUND

### Field

The present disclosure relates to an electronic brake system and an operation method thereof, and more particularly, to an electronic brake system, which includes both an electro-mechanical braking device and hydraulic braking device provided therein to put the brake on a vehicle with hydraulic pressure in case of failure of electric components, and an operation method thereof.

### Description of the Related Art

A brake system for performing braking is requisitely mounted on a vehicle, and various types of brake systems are proposed for the safety of drivers and passengers.

A brake system in related art primarily adopts a scheme of supplying liquid pressure required for braking to a wheel cylinder through a mechanically connected booster when the driver steps on a brake pedal. However, as the market demand for implementing various braking functions specifically in response to the operating environment of the vehicles increases, recently, an electronic brake system for receiving a driver's braking intention as an electrical signal from a pedal displacement sensor for detecting a displacement of a brake pedal when the driver steps on the brake pedal and braking a wheel based thereon has been widely used.

In the electronic braking system, there are an actuator driven by the electric motor and an electro-mechanical brake (EMB) which never uses hydraulic pressure using a mechanical operating principle. When such an electro-mechanical braking device operates in a normal operation mode, the operation of the brake pedal by the driver or braking determination upon autonomous driving of a vehicle are generated and provided as electrical signals, and based thereon, pressure required for braking is formed and transmitted to a wheel cylinder.

As such, although such an electronic brake system and an operation method thereof are electrically operated and controlled so that complex and various braking operations may be implemented, when a technical problem occurs in an electric component including an electric motor, a pressure required for braking may not be stably generated, and thus the safety of passengers may not be secured.

Therefore, the electronic brake system enters an abnormal operation mode when a component fails or becomes out of control, and in this case, a mechanism is required in which the operation of the brake pedal by a driver is directly linked to the wheel cylinders. That is, in the abnormal operation mode in the electronic brake system, as the driver applies pedal force to the brake pedal, a liquid pressure required for braking needs to be generated immediately and transferred directly to the wheel cylinders. Furthermore, there is a need for a method of accurately and quickly inspecting whether the electronic brake system fails in order to quickly enter the abnormal operation mode upon emergency and achieve the safety of passengers.

### SUMMARY

An object to be achieved by the present disclosure is to provide an electronic brake system and an operation method thereof which can put the brake on a vehicle even when a technical problem occurs in an electric component.

Another object to be achieved by the present disclosure is to provide an electronic brake system and an operation method thereof which can put the brake on the vehicle by generating a hydraulic pressure with a force with which a driver steps on a brake pedal even when the technical problem occurs in the electric component.

Still another object to be achieved by the present disclosure is to provide an electronic brake system and an operation method thereof which can determine sealing of a component against generation of the hydraulic pressure when the technical problem occurs in the electric component.

Yet another object to be achieved by the present disclosure is to provide an electronic brake system and an operation method thereof which can implement the abnormal operation state and diagnosis state by a simple structure and operation.

According to an aspect of the present disclosure, an electronic brake system includes: a plurality of actuators provided in a plurality of wheels, respectively and providing power for braking; and a hydraulic braking device providing braking force by a hydraulic pressure to at least one wheel cylinder of the plurality of wheels when the actuator is inoperable, the hydraulic braking device includes a reservoir storing a pressing medium, a master cylinder including a master piston connected to a brake pedal, a master chamber of which a volume is varied by displacement of the master piston, and a pedal simulator disposed inside the master chamber and providing a pedal feeling through an elastic restoration force generated during compression, a connection path connecting the master chamber and the wheel cylinder, and a cut valve provided in the connection path, and controlling a flow of the pressing medium between the master cylinder and the wheel cylinder.

The hydraulic braking device may include a reservoir path connecting the reservoir and the master chamber, and a simulator valve provided in the reservoir path, and controlling the flow of the pressing medium between the reservoir and the master chamber.

The reservoir path may include a first reservoir path provided with the simulator valve, and a second reservoir path branched between the reservoir and the simulator valve, and the master cylinder may include a first hydraulic port communicating the master chamber and the first reservoir path with each other, a second hydraulic port communicating the master chamber and the connection path with each other, and a third hydraulic port communicating the master chamber and the second reservoir path with each other.

The simulator valve may include a first simulator valve provided in the first reservoir path, and controlling the flow of the pressing medium between the reservoir and the master chamber, and a second simulator valve provided in the second reservoir path, and controlling the flow of the pressing medium between the reservoir and the master chamber.

The hydraulic braking device may include a sealing member provided between an outer peripheral surface of the master piston and a cylinder body of the master chamber to seal the master chamber.

The sealing member may include a first sealing member provided in a front of the third hydraulic port, and blocking a flow of the pressing medium introduced into the second reservoir path from the master chamber, and a second sealing member provided in a rear of the third hydraulic port and sealing the master chamber from the outside.

The hydraulic braking device may further include a pressure sensor provided in the connection path and sensing a liquid pressure of the master cylinder.

The pressure sensor may be provided between the cut valve and the wheel cylinder.

The hydraulic braking device may include a backup path of which one end is connected between the simulator valve on the reservoir path, and the master cylinder, and the other end is connected between the cut valve on the connection path, and the wheel cylinder.

The first hydraulic port and the second hydraulic port may be provided in the front of the first sealing member.

The connection path may include a first connection path provided with the cut valve, and a second connection path branched between the cut valve and the second hydraulic port, and the master cylinder may include a fourth hydraulic port provided between the first sealing member and the second sealing member, and communicating the master chamber and the second connection path with each other.

The plurality of wheels may include four wheels, and the hydraulic braking device may be provided in wheel cylinder of two wheels disposed in a front among the four wheels.

The brake pedal may include a pedal displacement sensor sensing displacement, and the actuator provided in the wheel cylinder may operate by receiving an electrical signal from the pedal displacement sensor.

According to another aspect of the present disclosure, provided is an operation method of an electronic brake system including a plurality of actuators provided in a plurality of wheels, respectively and providing power for braking, and a hydraulic braking device providing braking force by a hydraulic pressure to at least one wheel cylinder of the plurality of wheels when the actuator is inoperable, in which when the electronic brake system is in a normal operation mode, a simulator valve is opened, which controls a flow of a pressing medium in a reservoir path connecting a reservoir storing the pressing medium and a master chamber provided in a master cylinder, and a cut valve is closed, which controls the flow of the pressing medium in a connection path connecting the master chamber and the wheel cylinder, the actuator brakes a wheel by receiving an electrical signal of a pedal displacement sensor sensing a braking intension of a driver, and a pedal simulator disposed inside the master chamber provides a pedal feeling to the driver through an elastic restoration force generated during compression.

The operation method of an electronic brake system may be provided, in which when the electronic brake system is in an abnormal operation mode, the simulator valve is closed, the cut valve is opened, a master piston connected to a brake pedal moves to a front by the braking intention of the driver to reduce a volume of the master chamber, and a pressing medium accommodated in the master chamber flows to the wheel cylinder through the connection path to put the brake on a wheel.

The operation method of an electronic brake system may be provided, in which the reservoir path includes a first reservoir path provided with the simulator valve, a second reservoir path branched between the reservoir and the simulator valve, and a third hydraulic port communicating the master chamber and the second reservoir path with each other, and disposed in a rear of a first sealing member blocking a flow of a pressing medium introduced into the second reservoir path from the master chamber, and when the electronic brake system is in the abnormal operation mode, the master piston moves to a rear to discharge the pressing medium stored in the reservoir to the master chamber through the second reservoir path.

The operation method of an electronic brake system may be provided, in which the hydraulic braking device includes a backup path of which one end is connected between the simulator valve on the reservoir path, and the master cylinder, and the other end is connected between the cut valve on the connection path, and the wheel cylinder, and when the electronic brake system is in the abnormal operation mode, the pressing medium accommodated in the master chamber flows to the wheel cylinder through the backup path to put the brake on the wheel.

The operation method of an electronic brake system may be provided, in which the hydraulic braking device further includes a pressure sensor provided in the connection path and sensing a liquid pressure of the master cylinder, and when the electronic brake system is in a first diagnosis mode, the simulator valve is closed, the cut valve is opened, a master piston connected to a brake pedal moves to a front by the braking intention of the driver to reduce a volume of the master chamber, and the pressure sensor senses the liquid pressure of the master cylinder, and determines that it is normal when the liquid pressure is higher than a predetermined level, and determines that there is a failure when the liquid pressure is lower than the predetermined level.

The operation method of an electronic brake system may be provided, in which in the reservoir path, a first simulator valve is provided in the first reservoir path and a second simulator valve is provided in the second reservoir path, the connection path includes a first connection path provided with the cut valve and a second connection path branched between the cut valve and the master chamber, the master cylinder includes a second sealing member provided in a rear of the third hydraulic port and sealing the master chamber from the outside, and a fourth hydraulic port provided between the first sealing member and the second sealing member, and communicating the master chamber and the second connection path with each other, when the electronic brake system is in a second diagnosis mode, the first simulator valve and the second simulator valve are closed, the cut valve is opened, the actuator operates to allow the pressing medium to flow to the master chamber from the wheel cylinder, and when there is no displacement of the brake pedal after the operation of the actuator is released, it is determined that it is normal and when there is the displacement, it is determined that there is a failure.

The operation method of an electronic brake system may be provided, in which the hydraulic braking device further includes a pressure sensor provided in the connection path and sensing a liquid pressure of the master cylinder, and when the electronic brake system is in a third diagnosis mode, the simulator valve is closed, the cut valve is opened, a master piston connected to a brake pedal moves to a front by the braking intention of the driver to reduce a volume of the master chamber, and the pressure sensor senses the liquid pressure of the master cylinder, and determines that it is normal when the liquid pressure is higher than a predetermined level, and determines that there is a failure when the liquid pressure is lower than the predetermined level.

The exemplary embodiment provides an electronic brake system and an operation method thereof which can put the brake on a vehicle even when a technical problem occurs in an electric component.

The exemplary embodiment provides an electronic brake system and an operation method thereof which can put the brake on the vehicle by generating a hydraulic pressure with a force with which a driver steps on a brake pedal even when the technical problem occurs in the electric component.

The exemplary embodiment provides an electronic brake system and an operation method thereof which can determine sealing of a component against generation of the hydraulic pressure when the technical problem occurs in the electric component.

The exemplary embodiment provides an electronic brake system and an operation method thereof which can implement the abnormal operation state and diagnosis state by a simple structure and operation.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a hydraulic circuit diagram illustrating a normal operation mode state of an electronic brake system according to a first exemplary embodiment of the present disclosure;

FIG. 2 is a hydraulic circuit diagram illustrating an abnormal operation mode state of the electronic brake system according to the first exemplary embodiment of the present disclosure;

FIG. 3 is a hydraulic circuit diagram illustrating a first diagnosis mode state of an electronic brake system according to a second exemplary embodiment of the present disclosure;

FIG. 4 is a hydraulic circuit diagram illustrating a normal operation mode state of the electronic brake system according to a third exemplary embodiment of the present disclosure;

FIG. 5 is a hydraulic circuit diagram illustrating a second diagnosis mode state of an electronic brake system according to the third exemplary embodiment of the present disclosure;

FIG. 6 is a hydraulic circuit diagram illustrating a normal operation mode state of an electronic brake system according to a fourth exemplary embodiment of the present disclosure;

FIG. 7 is a hydraulic circuit diagram illustrating a third diagnosis mode state of an electronic brake system according to the fourth exemplary embodiment of the present disclosure; and

FIG. 8 is a hydraulic circuit diagram illustrating a second diagnosis mode state of an electronic brake system according to the fourth exemplary embodiment of the present disclosure.

### DETAILED DESCRIPTION OF THE EMBODIMENT

Hereinafter, the exemplary embodiment will be described in detail with reference to the accompanying drawings. The following exemplary embodiment is to present the idea of the present disclosure to those skilled in the art to which the present disclosure pertains. The present disclosure is not limited to exemplary embodiments described herein and may be embodied in other forms. In the drawings, illustration of parts not related to the description will be omitted to clarify the present disclosure, and the size of a component may be slightly exaggerated and expressed to help understanding.

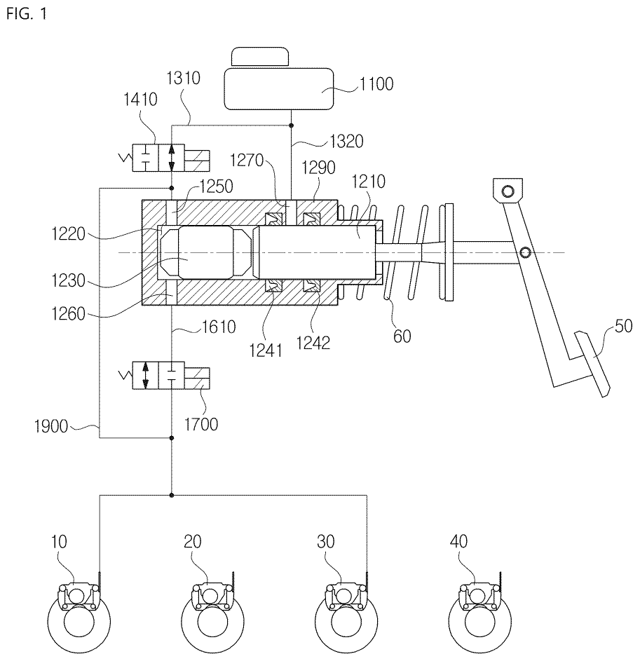

FIG. 1 is a hydraulic circuit diagram illustrating a normal operation mode state of an electronic brake system according to a first exemplary embodiment of the present disclosure.

Referring to FIG. 1, the electronic brake system according to the first exemplary embodiment of the present disclosure as an electronic brake system that puts the brake on a wheel with a plurality of actuators provided in a plurality of wheels, respectively and providing power for braking includes a hydraulic braking device providing braking force by a hydraulic pressure to at least one wheel cylinder of the plurality of wheels when the actuator is inoperable.

An electro-mechanical braking device brakes a vehicle by driving an electric caliper or an electronic disk by using a motor without the hydraulic pressure, and the hydraulic braking device 1000 brakes the vehicle by using the hydraulic pressure as a pressing medium. The electro-mechanical braking device is called a dry type because the electro-mechanical braking device does not use a fluid as the pressing medium, and the hydraulic braking device 1000 is called a wet type by using the fluid as the pressing medium.

Wheel cylinders of two wheels among four wheels provided in the vehicle may be provided with the hydraulic braking device 1000. Specifically, as in the first exemplary embodiment of the present disclosure, the hydraulic braking device 1000 may be provided in a front left wheel cylinder 10 and a front right wheel cylinder 20. However, the hydraulic braking device 1000 according to the present disclosure is not limited to the first exemplary embodiment, and the hydraulic braking device 1000 may be provided in a rear wheel cylinder, or one hydraulic braking device 1000 may be provided in each of a front wheel cylinder and the rear wheel cylinder.

The hydraulic braking device 1000 includes a reservoir 1100 storing the pressing medium, a master cylinder 1200 providing a reaction force against a pedal force of a brake pedal 50, and at the same time, pressing and discharging a pressing medium such as brake oil accommodated therein, a reservoir path 1300 hydraulically connecting the reservoir 1100 and the master cylinder 1200, a connection path 1600 connecting a master chamber 1220 and the wheel cylinder, a simulator valve 1400 as a solenoid valve which is provided in the reservoir path 1300, and a cut valve 1700 provided in the connection path 1600.

When a driver applies the pedal force to the brake pedal 50 for a braking operation, the master cylinder 1200 is provided to provide a reaction force against the pedal force to the driver to provide a stable pedal feeling, and at the same time, to press and discharge the pressing medium accommodated therein by operating the brake pedal 50.

The master cylinder 1200 includes a cylinder body 1290 forming an external form, and having the master chamber 1220 inside, and a master piston 1210 provided in the master chamber 1220, and connected to the brake pedal 50 and provided to be displaceable according to the operation of the brake pedal 50.

The master piston 1210 may be provided to be accommodated in the master chamber 1220, and may move forward (a left direction based on FIG. 1) to press the pressing medium accommodated in the master chamber 1220 to form a liquid pressure, or may move backward (a right direction based on FIG. 1) to form a negative pressure inside the master chamber 1220. The master piston 1210 may be provided to be elastically supported by a piston spring 60.

The master cylinder 1200 includes a sealing member 1240 provided between an outer peripheral surface of the master piston 1210, and the cylinder body 1290, and sealing the master chamber 1220. The sealing member 1240 may be provided to be seated on an accommodation groove dented on an inner peripheral surface of the cylinder body 1290, and to be in contact with the outer peripheral surface of the master piston 1210.

The sealing member 1240 may include a first sealing member 1320 provided in a front of a third hydraulic port 1270 to be described below and blocking a flow of the pressing medium introduced into a second reservoir path 1320 from the master chamber 1220, and allowing the flow of the pressing medium introduced into the master chamber 1220 from the second reservoir path 1320, and a second sealing member 1242 provided in the rear of the third hydraulic port 1270 and sealing the master chamber 1220 from the outside to prevent the pressing medium accommodated in the master chamber 1220 from being leaked to the outside, and at the same time, prevent external foreign substances from being introduced into the master chamber 1220.

In the present disclosure, the expressions front and rear are used. As an example, there are expressions of the front of the third hydraulic port 1270 and the rear of the third hydraulic port 1270. In this case, based on FIG. 1, the front means a left side of the master cylinder 1200, and the rear means a right side of the master cylinder 1200. Hereinafter, all front and rear expressions may be appreciated as such.

The master cylinder 1200 includes a pedal simulator 1230 provided inside the master chamber 1220 to provide the pedal feeling to the driver and providing an elastic restoration force generated during compression to the brake pedal 50. Specifically, the pedal simulator 1230 may be interposed between a front surface of the master piston 1210 and a front surface of the master chamber 1220, and may be made of an elastic material such as rubber which is compressible and expandable. The pedal simulator 1230 may include a cylindrical body portion, and a taper portion in which a diameter is gradually reduced toward a distal end. The elastic restoration force is changed according to a pedal force level of the brake pedal 50 by the taper portion to provide a stable and familiar pedal feeling to the driver.

The pressing medium may be introduced into and discharged from the first master chamber 1220 through the first hydraulic port 1250, the second hydraulic port 1260, and the third hydraulic port 1270. The first hydraulic port 1250 may be provided in the front of the first sealing member 1241. The first hydraulic port 1250 is connected to the first reservoir path 1310 to be described below, so the pressing medium may be introduced into the master chamber 1220 from the reservoir 1100, or the pressing medium accommodated in the master chamber 1220 may be discharged to the reservoir 1100. The third hydraulic port 1270 may be provided between the first sealing member 1241 and the second sealing member 1242. The third hydraulic port 1270 is connected to the second reservoir path 1320 to be described below, so the pressing medium may be introduced into the master chamber 1220 from the reservoir 1100, or the pressing medium accommodated in the master chamber 1220 may be discharged to the reservoir 1100. The second hydraulic port 1260 may be provided in the front of the first sealing member 1241. The second hydraulic port 1260 is connected to the first connection path 1610 to be described below, so the pressing medium may be discharged to the first connection path 1610 from the master chamber 1220, or on the contrary, the pressing medium may be introduced into the master chamber 1220 from the first connection path 1610.

The reservoir 1100 may accommodate and store the pressing medium therein. The reservoir 1100 is connected to the master cylinder 1200 to supply or receive the pressing medium. The reservoir 1100 may be provided as a single part or provided as a plurality of separate independent parts.

The reservoir path 1300 is provided to connect the master cylinder 1200 and the reservoir 1100.

The reservoir path 1300 may include a first reservoir path 1310 and a second reservoir path 1320 connecting the master chamber 1220 and the reservoir 1100. At this time, one end of the first reservoir path 1310 may be in communication with the master chamber 1220 by the first hydraulic port 1250 of the master cylinder 1200, and the other end may be in communication with the reservoir 1100, and one end of the second reservoir path 1320 may be in communication with the master chamber 1220 by the third hydraulic port 1270 of the master cylinder 1200, and the other end may be in communication with the reservoir 1100. The other end of the second reservoir path 1320 may be branched between the reservoir 1100 on the first reservoir path 1310, and the simulator valve 1400.

A first simulator valve 1410 is provided in the first reservoir path 1310 to control a flow of the pressing medium between the reservoir 1100 and the master chamber 1220. The first simulator valve 1410 may be provided as a normal closed-type solenoid valve which is in a closed state at normal times, and operates with a valve being opened when receiving an electrical signal from an electronic control unit, and may be opened in a normal operation mode of the electronic brake system.

The connection path 1600 is provided to connect the master chamber 1220 and the wheel cylinder.

The connection path 1600 includes a first connection path 1610 connecting the master chamber 1220 and the wheel cylinder. The cut valve 1700 is provided in the first connection path 1610 to control the flow of the pressing medium between the master cylinder 1200, and the wheel cylinder braked by the hydraulic pressure. The cut valve 1700 may be provided as a normal opened-type solenoid valve which is in an opened state at normal times, and operates with a valve being closed when receiving the electrical signal from an electronic control unit, and may be closed in the normal operation mode of the electronic brake system.

A backup path 1900 connects the first reservoir path 1310 and the first connection path 1610. One end of the backup path 1900 may be connected between the simulator valve 1400 on the first reservoir path 1310, and the master cylinder 1200, and the other end may be connected between the cut valve 1700 on the first connection path 1610, and the wheel cylinder braked by the hydraulic pressure.

The electro-mechanical braking device includes an electric motor. The electric motor may be provided to include a stator and a rotor, and rotates in a forward direction or a reverse direction to provide power that generates displacement of a piston provided inside the wheel cylinder. A rotational angular velocity and a rotational angle of the electric motor may be precisely controlled by a motor control sensor. The electric motor is already widely known technology, so a detailed description will be omitted.

The brake pedal 50 includes a pedal displacement sensor (not illustrated) that senses a displacement of a pedal. Accordingly, the simulator valve 1400, the cut valve 1700, and the electric motor provided in the wheel cylinder operate by receiving the electrical signal from the pedal displacement sensor (not illustrated). Specifically, when the displacement of the brake pedal 50 is sensed by the pedal displacement sensor (not illustrated), the sensed signal is transmitted to the electronic control unit, and the electronic control unit opens the simulator valve 1400, and closes the cut valve 1700, and rotates the motor in a direction of putting the brake on the wheel. On the contrary, when the pedal force of the brake pedal 50 is released, states of the simulator valve 1400 and the cut valve 1700 are not changed, and the motor is rotated in a direction of releasing the braking of the wheel.

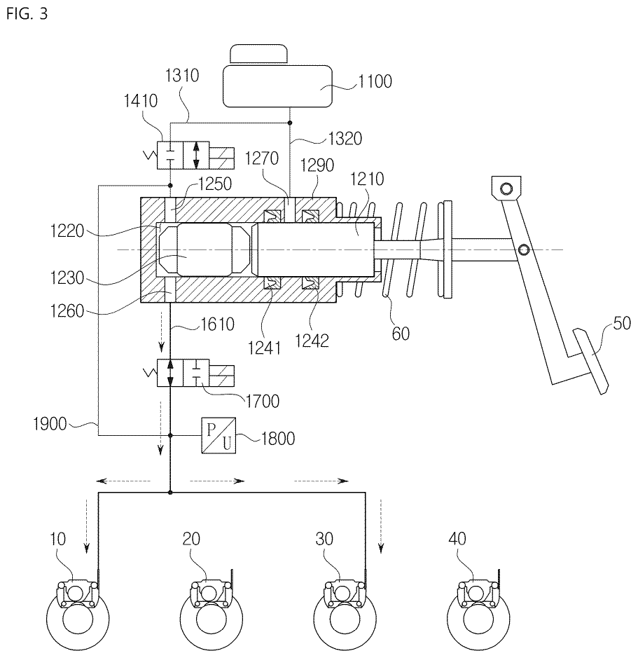

FIG. 3 is a hydraulic circuit diagram illustrating a first diagnosis mode state of an electronic brake system according to a second exemplary embodiment of the present disclosure.

Referring to FIG. 3, the electronic brake system according to the second exemplary embodiment of the present disclosure further includes a pressure sensor 1800 in the first exemplary embodiment.

The pressure sensor 1800 is provided in the connection path 1600 to sense the liquid pressure of the master cylinder 1200. Specifically, the pressure sensor 1800 may be provided between the cut valve 1700 on the connection path 1600, and the wheel cylinder braked by the hydraulic pressure. The pressure sensor 1800 may transmit, to the electronic control unit, sensed pressure value information of the pressing medium, and the electronic control unit may check whether the master chamber 1220 is sealed through a liquid pressure value sensed by the pressure sensor 1800. An operation aspect of checking whether sealing is made will be described later in detail.

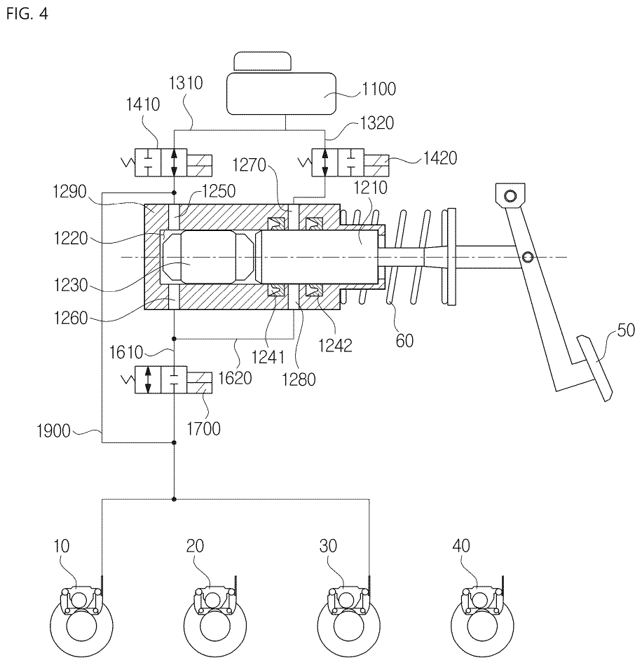

FIG. 4 is a hydraulic circuit diagram illustrating a normal operation mode state of the electronic brake system according to a third exemplary embodiment of the present disclosure.

Referring to FIG. 4, the electronic brake system according to the third exemplary embodiment of the present disclosure further includes a second simulator valve 1420, a fourth hydraulic port 1280, and a second connection path 1620 in the first exemplary embodiment.

The second simulator valve 1420 is provided in the second reservoir path 1320 to control the flow of the pressing medium between the reservoir 1100 and the master chamber 1220. The second simulator valve 1420 may be provided as the normal closed-type solenoid valve which is in the closed state at normal times, and operates with the valve being opened when receiving the electrical signal from an electronic control unit, and may be opened in the normal operation mode of the electronic brake system similarly to the first simulator valve 1410.

The second hydraulic port 1280 is connected to the first connection path 1620 to be described below, so the pressing medium may be discharged to the second connection path 1620 from the master chamber 1220, or on the contrary, the pressing medium may be introduced into the master chamber 1220 from the second connection path 1620.

The connection path 1600 includes a second connection path 1620 connecting the master chamber 1220 and the wheel cylinder. One end of the second connection path 1620 may be connected to the fourth hydraulic port 1280, and the other end may be branched and connected between the cut valve 1700 on the first connection path 1610, and the second hydraulic port 1260.

In the third exemplary embodiment of the present disclosure, the second simulator valve 1420 is adjusted to check whether the master chamber 1220 is sealed. An operation aspect of checking whether sealing is made will be described later in detail.

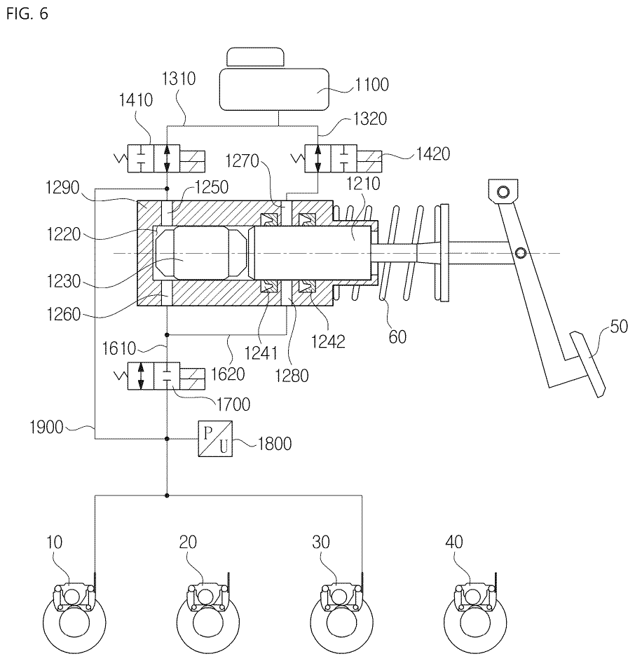

FIG. 6 is a hydraulic circuit diagram illustrating a normal operation mode state of an electronic brake system according to a fourth exemplary embodiment of the present disclosure.

Referring to FIG. 6, the electronic brake system according to the fourth exemplary embodiment of the present disclosure further includes a pressure sensor 1800 in the third exemplary embodiment.

At this time, the pressure sensor 1800 included in the fourth exemplary embodiment is the same component as the pressure sensor 1800 of the second exemplary embodiment. Accordingly, the electronic brake system according to the fourth exemplary embodiment may perform all of the operations of checking whether the master chamber 1220 is sealed performed in the second and third exemplary embodiments. An operation aspect of checking whether sealing is made will be described later in detail.

Hereinafter, an operation method of the electronic brake system according to an exemplary embodiment of the present disclosure will be described.

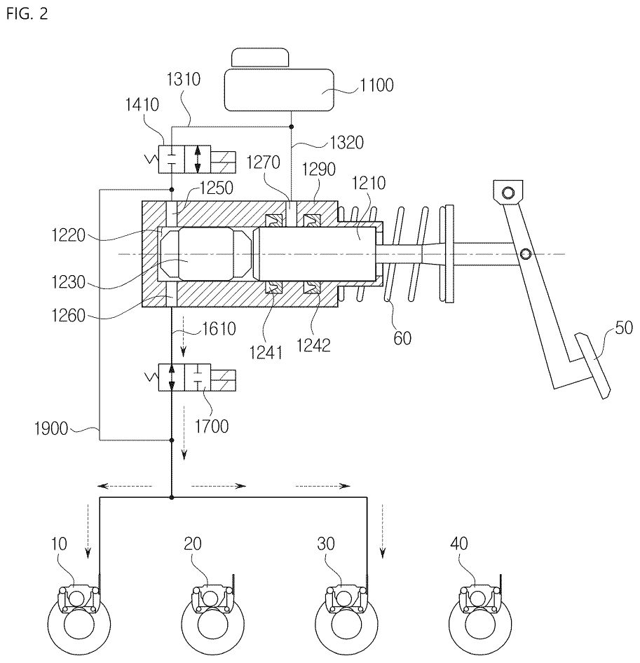

FIG. 1 is a hydraulic circuit diagram illustrating a normal operation mode state of an electronic brake system according to a first exemplary embodiment of the present disclosure, and FIG. 2 is a hydraulic circuit diagram illustrating an abnormal operation mode state of the electronic brake system according to the first exemplary embodiment of the present disclosure.

Referring to FIG. 1, an opening/closing state of a solenoid valve according to a normal operation mode state of the electronic brake system according to the first exemplary embodiment of the present disclosure may be checked.

First, the first simulator valve 1410 is opened, which controls the flow of the pressing medium in the first reservoir path 1310 connecting the reservoir 1100 storing the pressing medium and the master chamber 1220 provided in the master cylinder 1200, and the cut valve 1700 is closed, which controls the flow of the pressing medium in the connection path 1600 connecting the master chamber 1220, and the wheel cylinder braked by the hydraulic pressure.

Thereafter, when the driver steps on the brake pedal 50 to move the master piston 1210 forward, the pressing medium accommodated in the master chamber 1220 flows to the reservoir 1100 through the first reservoir path 1310 provided with the first simulator valve 1410. Further, the pedal displacement sensor (not illustrated) provided in the brake pedal 50 senses the braking intention of the driver to send the electrical signal to the motor provided in the wheel cylinder, and the motor rotates in the direction of putting the brake on the wheel.

At this time, the pedal simulator 1230 disposed in the master chamber 1220 provides the elastic restoration force generated during compression to the master piston 1210 to provide the pedal feeling to the driver.

Referring to FIG. 2, the opening/closing state of the solenoid valve and the flow of the pressing medium according to an abnormal operation mode state of the electronic brake system according to the first exemplary embodiment of the present disclosure may be checked.

In the electronic brake system, when a failure occurs in an electric component, the first simulator valve 1410 which is first opened is closed, and the closed cut valve 1700 is opened.

Thereafter, when the driver steps on the brake pedal 50 to move the master piston 1210 forward, a volume of the master chamber 1220 is reduced, and the pressing medium accommodated in the master chamber 1220 flows to the wheel cylinder braked by the hydraulic pressure through the connection path 1600. Accordingly, since the electronic brake system according to the first exemplary embodiment may operate the brake without depending on the electric component while including the electrical braking device braking the vehicle by using the electric motor, the electronic brake system may implement a passive fallback mode. That is, even when a technical problem occurs in the electric component, the liquid pressure required for braking is stably formed to achieve the safety of a passenger.

At this time, when the second reservoir path 1320 branched between the reservoir 1100 and the simulator valve 1400, and the third hydraulic port 1270 which communicates the master chamber 1220 and the second reservoir path 1320 with each other, and is disposed in the rear of the first sealing member 1241 blocking the flow of the pressing medium introduced into the second reservoir path 1320 from the master chamber 1220 are included, and the master piston 1210 moves backward, the pressing medium stored in the reservoir 1100 may be discharged to the master chamber 1220 through the second reservoir path 1320. Accordingly, when the electronic brake system is in the abnormal operation mode, the master chamber 1220 may be refilled with the pressing medium from the reservoir 1100 through the second reservoir path 1320.

Further, the hydraulic braking device 1000 may include the backup path 1900 of which one end may be connected between the simulator valve 1400 on the reservoir path 1300, and the master cylinder 1200, and the other end may be connected between the cut valve 1700 on the connection path 1600, and the wheel cylinder braked by the hydraulic pressure. Accordingly, when the electronic brake system is in the abnormal operation mode, the pressing medium accommodated in the master chamber 1220 flows to the wheel cylinder braked by the hydraulic pressure through the backup path 1900 to put the brake on the wheel. That is, even though a problem occurs in the opening state due to the failure of the cut valve 1700, the pressing medium may flow to the wheel cylinder.

FIG. 3 is a hydraulic circuit diagram illustrating a first diagnosis mode state of an electronic brake system according to a second exemplary embodiment of the present disclosure.

Referring to FIG. 3, the opening/closing state of the solenoid valve and the flow of the pressing medium according to a first diagnosis mode state of the electronic brake system according to the second exemplary embodiment of the present disclosure may be checked.

The first diagnosis mode is a process of diagnosing the sealing of the master chamber 1220 against the abnormal operation mode of the electronic brake system. Specifically, the first diagnosis mode may diagnose the sealing of the first sealing member 1241 and the first simulator valve 1410.

When the first diagnosis mode starts, first, the first simulator valve 1410 is closed and the cut valve 1700 is opened.

Thereafter, the master piston 1210 connected to the brake pedal 50 moves forward by a braking intention of the driver, so the volume of the master chamber 1220 is reduced, and the pressure sensor 1800 senses the liquid pressure of the master cylinder 1200.

At this time, unless the pressing medium of the master chamber 1220 is leaked to the reservoir 1100 or the outside by passing through the first sealing member 1241 or the first simulator valve 1410, the liquid pressure sensed by the pressure sensor 1800 increases to a predetermined level or more. Accordingly, the pressure sensor 1800 that senses the liquid pressure of the master cylinder 1200 may determine that it is in a normal state when the liquid pressure is higher than the predetermined level and determine that the first sealing member 1241 or the first simulator valve 1410 fails when the liquid pressure is lower than the predetermined level.

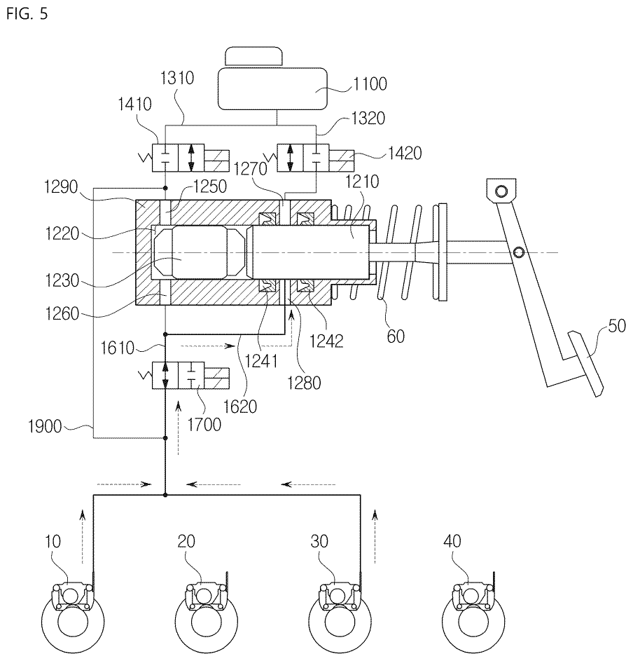

FIG. 4 is a hydraulic circuit diagram illustrating a normal operation mode state of an electronic brake system according to a third exemplary embodiment of the present disclosure, and FIG. 5 is a hydraulic circuit diagram illustrating a second diagnosis mode state of the electronic brake system according to the third exemplary embodiment of the present disclosure.

Referring to FIG. 4, an opening/closing state of a solenoid valve according to a normal operation mode state of the electronic brake system according to the third exemplary embodiment of the present disclosure may be checked.

The electronic brake system according to the third exemplary embodiment of the present disclosure further includes a second connection path 1620 branched between the cut valve 1700 and the master chamber 1220, a fourth hydraulic port 1280 provided between the first sealing member 1241 and the second sealing member 1242, and communicating the master chamber 1220 and the second connection path 1620 with each other, and a second simulator valve on the second reservoir path 1320 by comparing to the first exemplary embodiment.

Accordingly, the opening/closing of the solenoid valve and the flow of the pressing medium in the normal operation mode state of the electronic brake system according to the third exemplary embodiment of the present disclosure are the same as those in the normal operation mode of the electronic brake system according to the first exemplary embodiment except the second simulator valve is opened.

Referring to FIG. 5, the opening/closing state of the solenoid valve and the flow of the pressing medium according to a second diagnosis mode state of the electronic brake system according to the third exemplary embodiment of the present disclosure may be checked.

The second diagnosis mode is a process of diagnosing the sealing of the master chamber 1220 against the abnormal operation mode of the electronic brake system. Specifically, the second diagnosis mode may diagnose the sealing of the second sealing member 1242, and the first simulator valve 1410 and the second simulator valve.

When the second diagnosis mode starts, first, the first simulator valve 1410 and the second simulator valve are closed and the cut valve 1700 is opened.

Thereafter, the motor of the hydraulic braking device 1000 is operated so that the pressing medium flows to the master chamber 1220. After the motor is operated for a predetermined time, the operation of the motor is released.

At this time, unless the pressing medium of the master chamber 1220 is leaked to the reservoir 1100 or the outside by passing through the second sealing member 1242, the first simulator valve 1410 or the second simulator valve 1420, there is no displacement of the brake pedal 50 even though a time elapses. Accordingly, it may be determined there it is normal when there is no displacement of the brake pedal 50 after releasing the operation of the motor, and it may be determined that there is a failure when there is a displacement of the brake pedal 50.

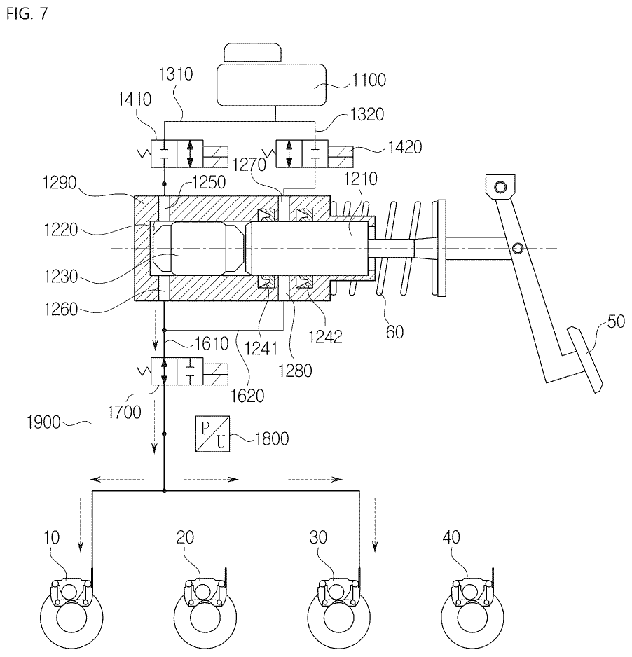

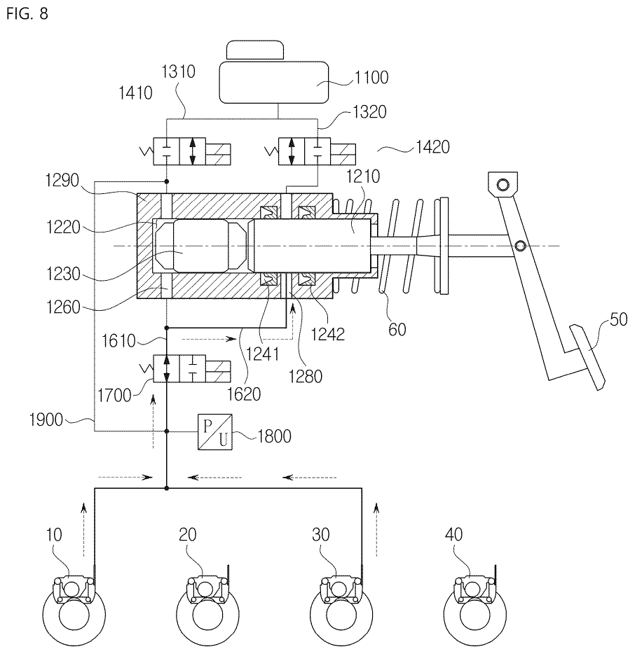

FIG. 6 is a hydraulic circuit diagram illustrating a normal operation mode state of an electronic brake system according to a fourth exemplary embodiment of the present disclosure, FIG. 7 is a hydraulic circuit diagram illustrating a third diagnosis mode state of an electronic brake system according to the fourth exemplary embodiment of the present disclosure, and FIG. 8 is a hydraulic circuit diagram illustrating a second diagnosis mode state of an electronic brake system according to the fourth exemplary embodiment of the present disclosure.

Referring to FIG. 6, the opening/closing state of the solenoid valve according to a normal operation mode state of the electronic brake system according to the fourth exemplary embodiment of the present disclosure may be checked.

In the electronic brake system according to the fourth exemplary embodiment of the present disclosure, the hydraulic braking device 1000 further includes a pressure sensor 1800 provided in the connection path 1600, and sensing the liquid pressure of the master cylinder 1200 by comparing to the third exemplary embodiment.

Accordingly, the opening/closing of the solenoid valve and the flow of the pressing medium in the normal operation mode state of the electronic brake system according to the fourth exemplary embodiment of the present disclosure are the same as those in the normal operation mode of the electronic brake system according to the third exemplary embodiment.

Referring to FIG. 7, the opening/closing state of the solenoid valve and the flow of the pressing medium according to the third diagnosis mode state of the electronic brake system according to the fourth exemplary embodiment of the present disclosure may be checked, and referring to FIG. 8, the opening/closing state of the solenoid valve and the flow of the pressing medium according to the second diagnosis mode state of the electronic brake system according to the fourth exemplary embodiment of the present disclosure may be checked.

The third diagnosis mode of the fourth exemplary embodiment is the same as the first diagnosis mode in the second exemplary embodiment except the second simulator valve 1420 is closed, and accordingly, the sealing of the second simulator valve 1420 may be additionally diagnosed. Further, the second diagnosis mode of the fourth exemplary embodiment is the same as the second diagnosis mode in the third exemplary embodiment.

Accordingly, the fourth exemplary embodiment includes all detailed components of the first to third exemplary embodiments, so the abnormal operation mode of the electronic brake system according to the first exemplary embodiment, the third diagnosis mode similar to the first diagnosis mode of the electronic brake system according to the second exemplary embodiment, and the second diagnosis mode of the electronic brake system according to the third exemplary embodiment may be all implemented. When the electronic brake system according to the exemplary embodiment of the present disclosure performs the abnormal operation mode, the abnormal operation mode may be implemented without requiring a liquid pressure generation device and the resulting multiple valves, and the first diagnosis mode and the second diagnosis mode may be realized only by components used in the normal operation mode and the abnormal operation mode, so the abnormal operation state and diagnosis state may be implemented by a simple structure and a simple operation.

While the present disclosure has been described in connection with what is presently considered to be practical exemplary embodiments, it is to be understood that the present disclosure is not limited to the disclosed exemplary embodiments, but, on the contrary, is intended to cover various modifications and equivalent arrangements included within the spirit and scope of the appended claims.

What is claimed is:

1. An electronic brake system comprising:
a plurality of actuators provided in a plurality of wheels, respectively and providing power for braking; and
a hydraulic braking device providing braking force by a hydraulic pressure to at least one wheel cylinder of the plurality of wheels when the actuator is inoperable,
wherein the hydraulic braking device includes
a reservoir storing a pressing medium,
a master cylinder including a master piston connected to a brake pedal, a master chamber of which a volume is varied by displacement of the master piston, and a pedal simulator disposed inside the master chamber and providing a pedal feeling through an elastic restoration force generated during compression,
a connection path connecting the master chamber and the wheel cylinder, and
a cut valve provided in the connection path, and controlling a flow of the pressing medium between the master cylinder and the wheel cylinder.

2. The electronic brake system according to claim 1, wherein the hydraulic braking device includes
a reservoir path connecting the reservoir and the master chamber, and
a simulator valve provided in the reservoir path, and controlling the flow of the pressing medium between the reservoir and the master chamber.

3. The electronic brake system according to claim 2, wherein the reservoir path includes
a first reservoir path provided with the simulator valve, and
a second reservoir path branched between the reservoir and the simulator valve, and
the master cylinder includes
a first hydraulic port communicating the master chamber and the first reservoir path with each other,
a second hydraulic port communicating the master chamber and the connection path with each other, and
a third hydraulic port communicating the master chamber and the second reservoir path with each other.

4. The electronic brake system according to claim 3, wherein the simulator valve includes
a first simulator valve provided in the first reservoir path, and controlling the flow of the pressing medium between the reservoir and the master chamber, and
a second simulator valve provided in the second reservoir path, and controlling the flow of the pressing medium between the reservoir and the master chamber.

5. The electronic brake system according to claim 3, wherein the hydraulic braking device includes a sealing member provided between an outer peripheral surface of the master piston and a cylinder body of the master chamber to seal the master chamber.

6. The electronic brake system according to claim 5, wherein the sealing member includes
a first sealing member provided in a front of the third hydraulic port, and blocking the flow of the pressing medium introduced into the second reservoir path from the master chamber, and
a second sealing member provided in a rear of the third hydraulic port and sealing the master chamber from outside.

7. The electronic brake system according to claim 1, wherein the hydraulic braking device further includes a pressure sensor provided in the connection path and sensing a liquid pressure of the master cylinder.

8. The electronic brake system according to claim 7, wherein the pressure sensor is provided between the cut valve and the wheel cylinder.

9. The electronic brake system according to claim 2, wherein the hydraulic braking device includes a backup path of which one end is connected between the simulator valve on the reservoir path, and the master cylinder, and the other end is connected between the cut valve on the connection path, and the wheel cylinder.

10. The electronic brake system according to claim 6, wherein the first hydraulic port and the second hydraulic port are provided in a front of the first sealing member.

11. The electronic brake system according to claim 6, wherein the connection path includes
a first connection path provided with the cut valve, and
a second connection path branched between the cut valve and the second hydraulic port, and
the master cylinder includes a fourth hydraulic port provided between the first sealing member and the second sealing member, and communicating the master chamber and the second connection path with each other.

12. The electronic brake system according to claim 1, wherein the plurality of wheels includes four wheels, and
the hydraulic braking device is provided in wheel cylinder of two wheels disposed in a front among the four wheels.

13. The electronic brake system according to claim 1, wherein the brake pedal includes a pedal displacement sensor sensing displacement, and
the actuator provided in the wheel cylinder operates by receiving an electrical signal from the pedal displacement sensor.

14. An operation method of an electronic brake system including a plurality of actuators provided in a plurality of wheels, respectively and providing power for braking, and a hydraulic braking device providing braking force by a hydraulic pressure to at least one wheel cylinder of the plurality of wheels when the actuator is inoperable, wherein when the electronic brake system is in a normal operation mode,
a simulator valve is opened, which controls a flow of a pressing medium in a reservoir path connecting a reservoir storing the pressing medium and a master chamber provided in a master cylinder, and
a cut valve is closed, which controls the flow of the pressing medium in a connection path connecting the master chamber and the wheel cylinder,
the actuator brakes a wheel by receiving an electrical signal of a pedal displacement sensor sensing a braking intension of a driver, and
a pedal simulator disposed inside the master chamber provides a pedal feeling to the driver through an elastic restoration force generated during compression.

15. The operation method of an electronic brake system according to claim 14, wherein when the electronic brake system is in an abnormal operation mode,
the simulator valve is closed,
the cut valve is opened,
a master piston connected to a brake pedal moves to a front by the braking intention of the driver to reduce a volume of the master chamber, and
the pressing medium accommodated in the master chamber flows to the wheel cylinder through the connection path to put the brake on the wheel.

16. The operation method of an electronic brake system according to claim 15, wherein the reservoir path includes a first reservoir path provided with the simulator valve, a second reservoir path branched between the reservoir and the simulator valve, and a third hydraulic port communicating the master chamber and the second reservoir path with each other, and disposed in a rear of a first sealing member blocking the flow of the pressing medium introduced into the second reservoir path from the master chamber, and
when the electronic brake system is in the abnormal operation mode,
the master piston moves to a rear to discharge the pressing medium stored in the reservoir to the master chamber through the second reservoir path.

17. The operation method of an electronic brake system according to claim 15, wherein the hydraulic braking device includes a backup path of which one end is connected between the simulator valve on the reservoir path, and the master cylinder, and the other end is connected between the cut valve on the connection path, and the wheel cylinder, and
when the electronic brake system is in the abnormal operation mode,
the pressing medium accommodated in the master chamber flows to the wheel cylinder through the backup path to put the brake on the wheel.

18. The operation method of an electronic brake system according to claim 15, wherein the hydraulic braking device further includes a pressure sensor provided in the connection path and sensing a liquid pressure of the master cylinder, and
when the electronic brake system is in a first diagnosis mode,
the simulator valve is closed,
the cut valve is opened,
the master piston connected to the brake pedal moves to the front by the braking intention of the driver to reduce the volume of the master chamber, and
the pressure sensor senses the liquid pressure of the master cylinder, and determines that it is normal when the liquid pressure is higher than a predetermined level, and determines that there is a failure when the liquid pressure is lower than the predetermined level.

19. The operation method of an electronic brake system according to claim 16, wherein in the reservoir path, a first simulator valve is provided in the first reservoir path and a second simulator valve is provided in the second reservoir path,
the connection path includes a first connection path provided with the cut valve and a second connection path branched between the cut valve and the master chamber,
the master cylinder includes a second sealing member provided in a rear of the third hydraulic port and sealing the master chamber from outside, and a fourth hydraulic port provided between the first sealing member and the second sealing member, and communicating the master chamber and the second connection path with each other,
when the electronic brake system is in a second diagnosis mode,
the first simulator valve and the second simulator valve are closed,
the cut valve is opened,
the actuator operates to allow the pressing medium to flow to the master chamber from the wheel cylinder, and
when there is no displacement of the brake pedal after the operation of the actuator is released, it is determined that it is normal and when there is the displacement, it is determined that there is a failure.

20. The operation method of an electronic brake system according to claim 19, wherein the hydraulic braking device further includes a pressure sensor provided in the connection path and sensing a liquid pressure of the master cylinder, and
when the electronic brake system is in a third diagnosis mode,
the simulator valve is closed,
the cut valve is opened,
the master piston connected to the brake pedal moves to the front by the braking intention of the driver to reduce the volume of the master chamber, and
the pressure sensor senses the liquid pressure of the master cylinder, and determines that it is normal when the liquid pressure is higher than a predetermined level, and determines that there is a failure when the liquid pressure is lower than the predetermined level.
